(19) United States
(12) Patent Application Publication
(10) Pub. No.: US 2005/0172008 A1
(43) Pub. Date: Aug. 4, 2005

(54) Managing network traffic for network-attached storage

(76) Inventors: Christopher H. Claudatos, San Jose, CA (US); Magnus B. Hansen, Fremont, CA (US)

Correspondence Address: FISH & RICHARDSON P.C., PO BOX 1022, MINNEAPOLIS, MN, 55440-1022, US

(21) Appl. No.: 10/769,548

(22) Filed: Jan. 30, 2004

(51) Int. Cl. G06F 15/16

(52) U.S. Cl. 709/219

(57) ABSTRACT

Methods and apparatus, including computer program products, implement techniques for processing data packets in a computer network. The computer network includes a network-attached storage appliance generating data packets and transmitting the generated data packets to the computer network, and a multiport network device receiving the generated data packets. The data packets are generated by packetizing a file, where the file has one or more associated file attributes. The network-attached storage appliance inserts a network-attached storage content descriptor in each generated data packet, where the content descriptor identifies one or more of the associated file attributes. The multiport network device is configured to process the received data packets according to the content descriptor, and the multiport network device processes the received data packets at wire speed.

### BACKGROUND

This invention relates to network switching, and more particularly to Layer 2 through Layer 7 switching.

The OSI (Open System Interconnection) Model is an ISO (International Standards Organization) standard for worldwide communications that defines a networking framework for implementing protocols in seven layers. Control is passed from one layer to the next, starting at the applications layer in one station, and proceeding to the physical layer and back up the hierarchy.

The layers are defined as:

Applications Layer 7 provides interface to end-user processes and standardized services to applications.

Presentation Layer 6 specifies architecture-independent data transfer format, encodes and decodes data, encrypts and decrypts data, compresses data.

Session Layer 5 manages user sessions and reports upper-layer errors.

Transport Layer 4 manages network layer connections and provides reliable packet delivery mechanism.

Network Layer 3 addresses and routes packets.

Data Link Layer 2 frames packets and controls physical layer data flow.

Physical Layer 1 interfaces between network medium and network devices. It also defines electrical and mechanical characteristics.

### SUMMARY OF THE INVENTION

The present invention provides methods and apparatus, including computer program products, for processing data packets in a computer network, the data packets including information from one or more of Layers 2 through 7 of the OSI model.

In one aspect the invention is directed to a computer network. The computer network includes a network-attached storage appliance generating data packets and transmitting the generated data packets to the computer network, and a multiport network device receiving the generated computer packets. The data packets are generated by packetizing a file having one or more associated file attributes. The network-attached storage appliance inserts a network-attached storage content descriptor in each generated data packet, where the content descriptor identifies one or more of the associated file attributes. The multiport network device is configured to process the received data packets according to the content descriptor. The multiport network device processes the received data packets at wire speed.

Implementations of the invention can include one or more of the following features. The file attributes can include one or more of file name, file extension, file size, and data format stored in the file. The multiport network device can be configured by a user to process the received data packets according to the content descriptor. The multiport network device can determine the content descriptor to be inserted by the network-attached storage appliance for the identified content type. A mapping table can be stored on the multiport network device, where the mapping table identifies one or more file attributes and provides the content descriptor to be inserted by the network-attached storage for each of the identified file attributes. The mapping table can be transmitted to the network-attached storage appliance, and the network-attached storage appliance can insert the content descriptors provided by the mapping table. Processing the data packets at the multiport network device can include selecting one of a plurality of network actions. Processing the data packets at the multiport network device can include allocating network bandwidth to the received data packets and monitoring the data packets received at the multiport network device. The multiport network device can be configured to process the data packets by blocking data packets from utilizing the computer network redirecting blocked data packets and logging blocked data packets. The multiport network device can be configured to process the data packets by reallocating network bandwidth to the received data packets based on the content type. The associated file attributes for each data packet can be determined by the network-attached storage appliance. The data packets can be generated by packetizing information contained in a file, and the associated file attributes can be determined based on a file name identifying the file. The data packets can be generated by packetizing information contained in a file, and the associated file attributes can be determined based on the file name extension of the file. A workstation connected to the network-attached storage appliance through the multiport network device can request a file from the network-attached storage appliance. Generating the data packets can include generating data packets containing the requested file, and transmitting the generated data packets can include transmitting the generated data packets to the workstation requesting the file. The multiport network device can store one or more user defined packet policies and can be configured to perform an action from a user-defined packet policy that matches the content descriptor. The multi-port network device can be configured to route the received data packet using a layer 2-3 switch.

The invention can be implemented to realize one or more of the following advantages. Marking data packets transmitted by a network-attached storage (NAS) appliance using a NAS content descriptor allows a network administrator to control network flows and bandwidth consumption in the network. The network administrator can specify the NAS content descriptor to be assigned to data packets containing a specified type of content. The network administrator can also specify the NAS content descriptor to be assigned to data packets based on one or more associated file attributes for the data packets. A multiport network device can be configured to route packets having a specific NAS content descriptor with a higher priority or to allocate a fixed percentage of the available bandwidth to packets having a specific NAS content descriptor. The content descriptor can be used to direct data packets to specific storage locations for the purpose of short or long term storage and necessity for quick retrieval. Short term storage hardware can be disk backup and long term hardware can be tape backup. The content descriptor can be used in combination with a time triggered action unit to transfer data packets from short term storage to long term storage after a designated time interval. One implementation of the invention can provide all of the above advantages.

The details of one or more implementations of the invention are set forth in the accompanying drawings and the description below. Further features, aspects, and advantages of the invention will become apparent from the description, the drawings, and the claims.

### BRIEF DESCRIPTION OF THE DRAWINGS

FIG. 1 shows a network topology including a multilayer switch.

FIG. 2A is a block diagram of an exemplary implementation of the switch.

FIG. 2B is a block diagram illustrating an alternative switch implementation including a time triggered action unit (TTA).

FIG. 2C is a block diagram of an implementation of the switch including a central management unit (CMU).

FIG. 3 is a block diagram illustrating the components of a packet policy.

FIG. 4 is a block diagram illustrating the types of packet policies that may be requested by the user.

FIG. 5 is a block diagram illustrating a method of operation of the packet filter engine.

FIG. 6 is a block diagram illustrating the components of a timed policy request to be processed by the TTA.

FIG. 7 is a flow diagram illustrating a method of processing a timed policy request.

FIG. 8 is a flow diagram illustrating activation of a packet policy scheduled using a timed policy request.

FIG. 9 illustrates a local area network including a network-attached storage (NAS) appliance connected to multiple workstations.

FIG. 10 is a block diagram of a data packet 1000 including a NAS content descriptor.

FIG. 11 is a flow diagram illustrating the transmission of data packets containing the NAS content descriptor by the NAS server.

FIG. 12 illustrates unused portions of an IP header that are used to insert the NAS content descriptor.

FIG. 13 is a flow diagram illustrating the processing of a data packet including a NAS content descriptor.

Like reference numbers and designations in the various drawings indicate like elements.

### DETAILED DESCRIPTION

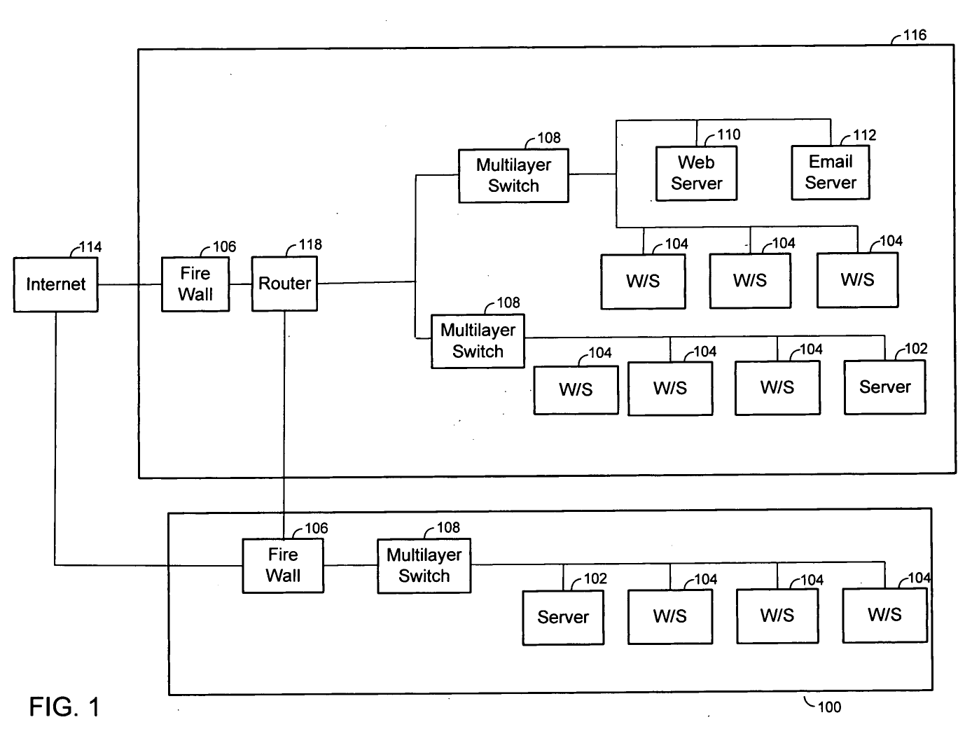

FIG. 1 shows a network topology including a local area network (LAN) 100, including a server 102, several workstations (W/S) 104, a firewall 106, and a multilayer switch 108. The LAN 100 is connected to an external network, e.g., the Internet 114, through the firewall 106. The LAN 100 is also connected to a second LAN 116 through the firewall 106. The second LAN 116 includes a web server 110, an email server 112, a server 102, several workstations 104, a firewall 106 and one or more multilayer switches 108. The computers, servers and other devices in the LAN are interconnected using a number of data transmission media such as wire, fiber optics, and radio waves. The router 118 processes packets based on Layer 3 information and routes the packets through the network. At least one of the multilayer switch 108 processes and routes packets at Layer 2 and Layer 3, but modifies the routing behavior based on the processing of information contained in Layers 2 through 7 of the packet. The multilayer switch 108 processes the information in Layer 2 through 7 of the packet in an amount of time available for routing a packet at Layer 2 (wire-speed).

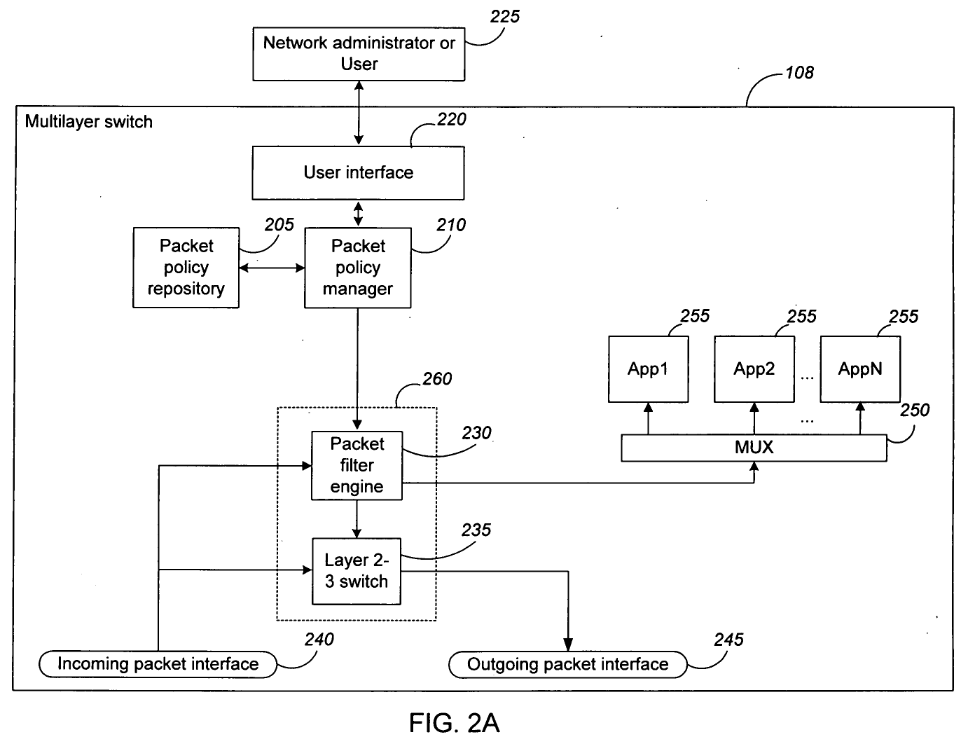

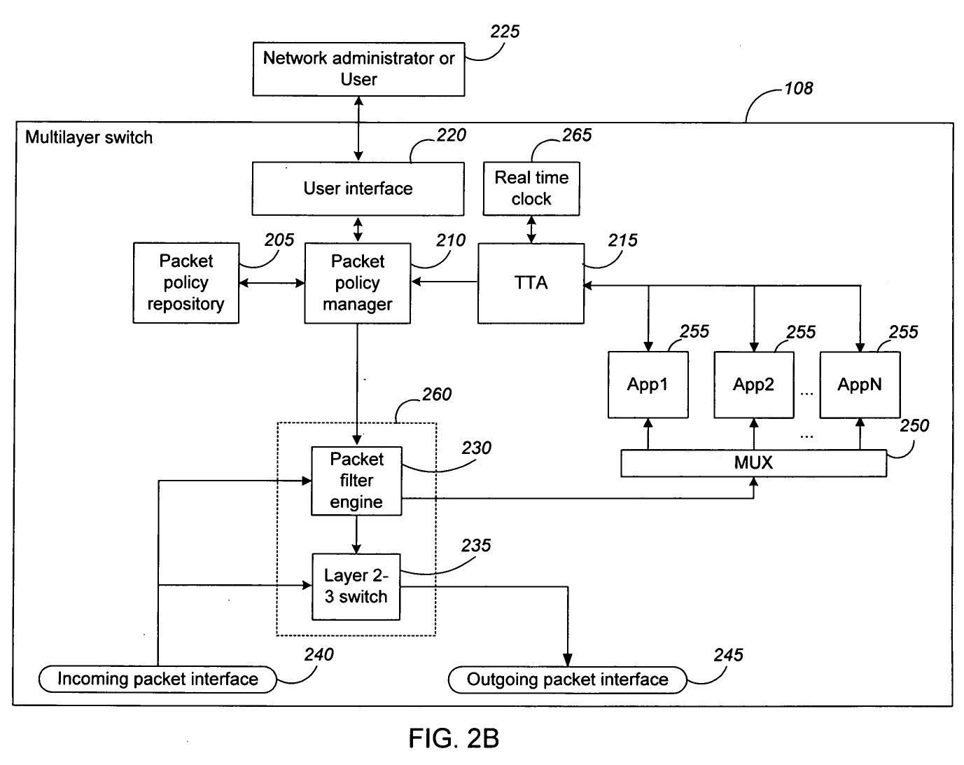

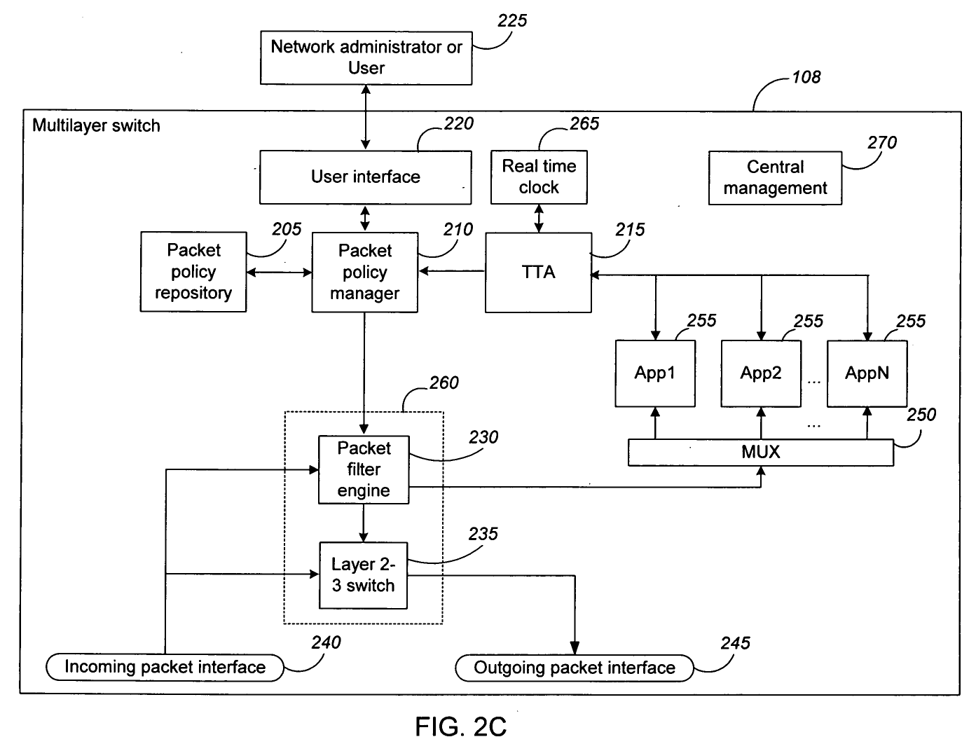

FIG. 2A shows a block diagram of an exemplary implementation of the switch 108. The switch 108 implements one or more packet policies that specify the action to be performed by the switch 108 when a packet is received that matches the conditions set in the policy. The switch 108 includes a packet policy manager (PPM) 210 and a packet filter engine (PFE) 230. The user or network administrator 225 interacts with the PPM 210 through the user interface 220 to specify the requested packet policies to be implemented by the switch 108. In one implementation, the switch 108 includes an HTTP server and the user interface displays a web page that can be used by the user 225 to specify the requested packet policies. The PPM stores the requested packet policies in the packet policy repository (PPR) 205. In one implementation, the PPM 210 assigns a packet policy identifier for each requested packet policy and the packet policies can be retrieved from the PPR 205 using the packet policy identifier. The PPM 210 transmits the requested packet policies to the PFE 230 in order to activate the packet policies. The PFE 230 stores the active packet policies along with the packet policy identifier for each active policy. The switch 108 receives data packets using the incoming packet interface 240. A data packet includes data being communicated in a computer network that has been packetized. A data packet also includes TCP/IP packets. The PFE 230 screens incoming data packets to determine if they match one of the requested packet policies. If the received data packet matches one of the requested packet policies, the PFE 230 can block the received data packet or modify the data packet as requested by the matching packet policy before routing. If the received data packet is not blocked by the PFE 230, it is routed by the Layer 2-3 switch 235 using the out going packet interface 245.

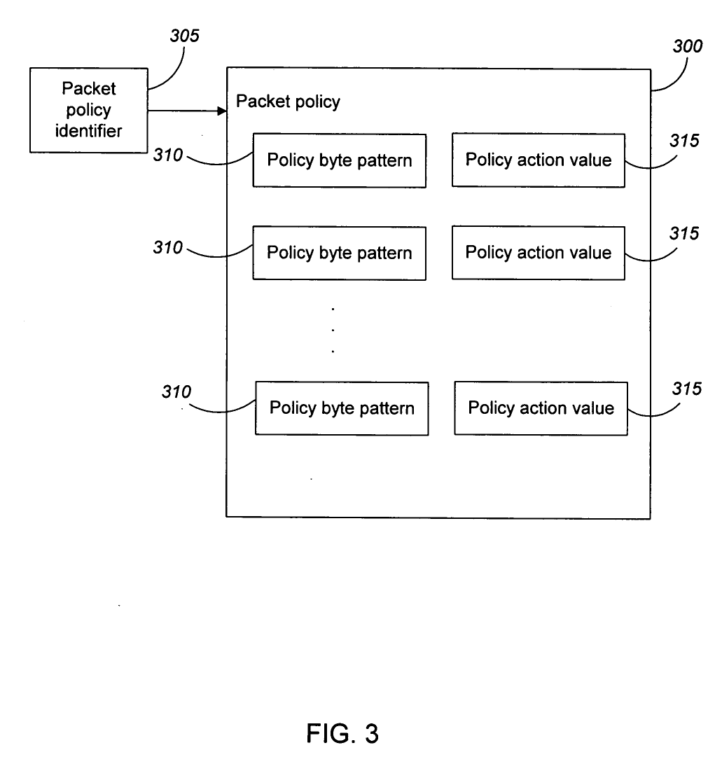

FIG. 3 is a block diagram illustrating the components of a packet policy 300. Each packet policy 300 can have an associated packet policy identifier 305 that can be used to access the packet policy. The packet policy 300 contains a policy byte pattern 310 and one or more policy action fields 315. Each policy action field 315 can also have an associated policy action value 320. The policy action field 315 specifies the processing of the received packet including whether the received packet should be routed, blocked, redirected, or cloned. The policy action field 315 can also specify modifications to be performed on the packet before it is routed. An incoming packet matches the packet policy 300 if the incoming pattern contains a sequence of bytes identical to the policy byte pattern 310. The policy action fields 315 specify one or more actions to be performed when a matching packet is received. The policy action value 320 specifies additional optional parameters for the policy action field 315. Table I is an exemplary list of values for the policy action field 315 along with a description of the action to performed for each value.

TABLE I

| Action | Function | Action Value |
|---|---|---|
| None | No sub service is selected in this policy. | None |
| Discard | Drops packets that match this policy | None |
| Flow Meter | Regulates the percentage of 1-100 | 10/100 ports: 1 = 1 Mbps |
| | bandwidth for packets that match this | Gigabit ports: 1 = 8 Mbps |
| | policy. The percentage is specified in the | Example: 5 |
| | policy action value. | |
| Mirror to Port | Mirrors packets that match this policy to | None |
| | the mirrored to port. Port mirroring must | |
| | be enabled on the switch. The mirror | |
| | port is specified when the switch is | |
| | configured. | |
| Redirect | Changes port of Egress for packets that | Ports 1-26, Example: 24 |
| | match this policy. The Egress port is | |
| | specified in the policy action value. | |
| Prioritize | Internally prioritizes packets that match | 0-7 |
| | this policy. The policy action value | Example: 5 |
| | specifies the priority. | |
| Do Not Drop | If a policy is created to drop a certain | None |
| | type of traffic this option can be selected | |
| | to not discard packets that match this | |
| | policy. | |
| Change 802.1p Tag | Redirects packet to a new CoS queue as | 0-7 |
| | specified by the policy action value. | Example: 3 |
| Change IPTOS | Redirects packet to a new CoS queue as | 0-7 |
| | specified by the policy action value. | Example: 3 |
| Change IPTOS to | Matches IPTOS to 802.1p | None |
| 802.1p | | |
| IP DiffServ | Modify the IP header to insert the | 0-31 |
| | “differential services code point” (DSCP) | Example: 11 |
| | as specified by the policy action value. | |

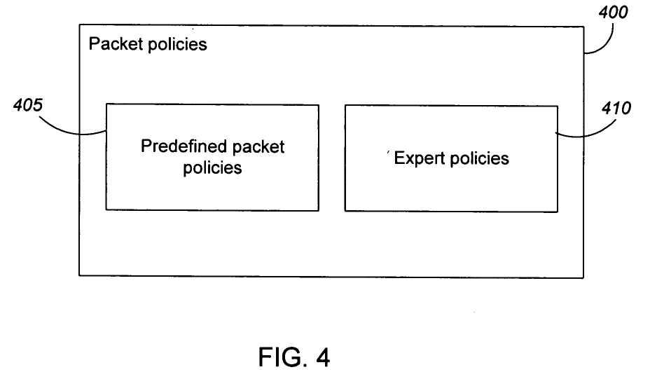

FIG. 4 is a block diagram illustrating the types of packet policies 400 that may be requested by the user. The requested packet policies can be selected from predefined packet policies 405 or expert packet policies 410. Referring to FIG. 3, expert packet policies 410 are user defined packet policies for which the user provides the policy byte pattern 310, the policy action fields 315, and the associated policy action values 320. Predefined packet policies 405 consist of packet policies that are used by a large number of users. The PPM (210, FIG. 2) provides the policy byte pattern 310 for predefined packet policies 405 and the user is not required to provide a byte pattern for these policies. The PPM 210 also provides default policy action fields 315 and policy action values 320 for each predefined packet policy 405. In one implementation, the user can customize a predefined packet policy 405 by modifying the policy action fields 315 and policy action values 320. Predefined packet policies 405 can include packet policies for commonly used applications like Yahoo Messenger, Microsoft Netmeeting, or interactive networked computer games. Predefined packet policies 405 can also include packet policies for known network security attacks like IP spoofing, and to block access to specific URLs.

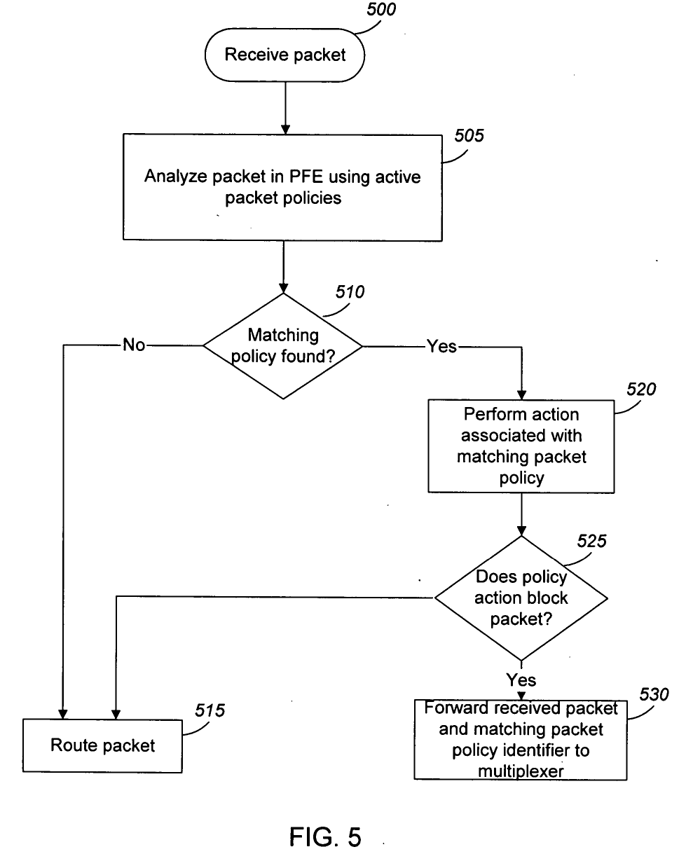

FIG. 5 is a flow diagram illustrating the method of operation of the PFE (230, FIG. 2). Incoming packets are received (step 500), and analyzed in the PFE 230 using the active packet policies (step 505). If there is no matching packet policy (“no” branch of decision step 510), the packet is routed by the Layer 2-3 switch (235, FIG. 2) (step 515). If there is a matching packet policy (“yes” branch of decision step 510), the actions specified in the policy action fields (315, FIG. 3) are performed (step 520). If the packet is not blocked by the policy action fields 315 of the matching policy (“no” branch of decision step 525), it is routed by the Layer 2-3 switch 235 (step 515). If the packet is blocked by the policy action fields 315 of the matching policy (“yes” branch of decision step 525), the blocked packet is forwarded to the multiplexer (250, FIG. 2) along with the packet policy identifier (305, FIG. 3) of the matching packet policy (step 530).

Referring to FIG. 2A, the multiplexer 250 forwards the blocked packet and the blocked policy identifier to one or more switch applications 255 running on the switch. In one implementation, the blocked packet and the associated packet policy identifier are also sent to other network devices external to the switch 108 for further processing. Switch applications 255 and external network devices can avoid analyzing the blocked packet by using the associated packet policy identifier to identify the matching policy for the blocked packet. In one exemplary embodiment of the switch 108, one of the network applications 255 can be a network address translation (NAT) application that receives and processes blocked NAT packets. In another exemplary embodiment of the switch 108, one of the network applications 255 can be a network security application that analyzes blocked packets for known attack signatures to determine if an attempted network security intrusion is in progress. The network security application can also transmit additional packet policies to the PFE 230 through the PPM 210 to block an attempted network security intrusion.

FIG. 2B is a block diagram illustrating an alternative implementation of the switch 108 including a time triggered action unit (TTA) 215. The TTA 215 allows the user to schedule timed packet policies that are used to filter incoming packets only during the specified time periods. The TTA 215 schedules the timed packet policies using a time reference obtained from a real time clock 265. The user can specify that a requested packet policy is to be used only during specified time periods. In one implementation of the switch 108, the TTA 215 is also used to schedule switch applications 255 to run during certain specified time periods.

FIG. 2C is a block diagram illustrating another implementation of the switch 108 including a central management unit (CMU) 270. As described later, the CMU 270 is used for performing firmware and configuration updates.

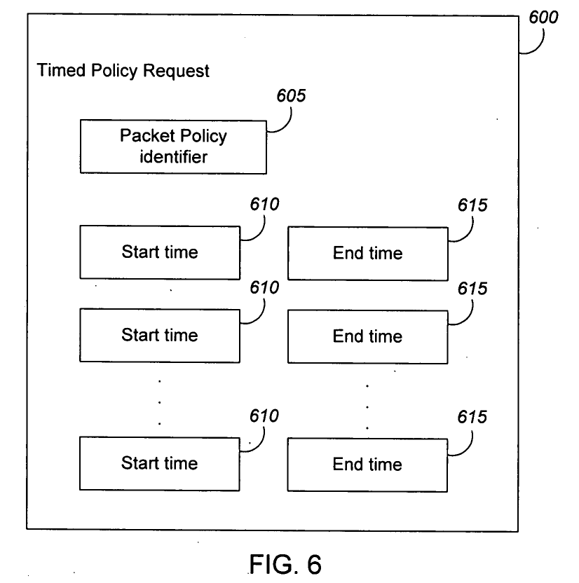

FIG. 6 is a block diagram illustrating a timed policy request 600 to be processed using the TTA (215, FIG. 2). The timed policy request 600 includes a packet policy identifier 605, and one or more pairs of start time 610 and end time 615 values. The packet policy identifier 605 identifies a policy that already been programmed by the user. The start time 610 and the end time 615 indicate the activation time and de-activation time for the policy identified by the packet policy identifier 605. If there is no end time for timed policy request 600, the policy identified by the packet policy identifier 605 is never deactivated after activation. A timed policy request 600 with no start time is used to de-activate an active policy identified by the packet policy identifier 605 at the specified end time 615. In one implementation, the timed policy request includes the packet policy to be scheduled instead of the packet policy identifier 605.

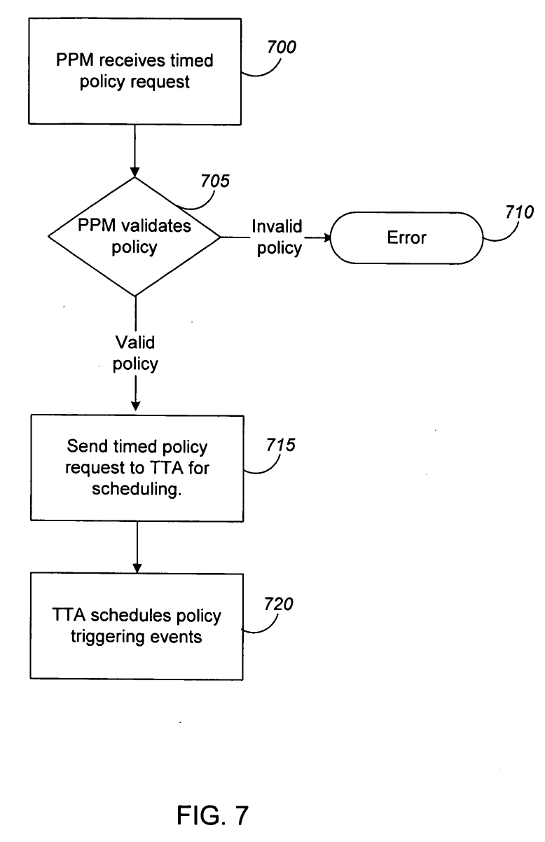

FIG. 7 is a flow diagram illustrating a method of processing a timed policy request (400, FIG. 4). Referring to FIG. 2 and FIG. 4, the PPM 210 receives a timed policy request 400 (step 700). The PPM 210 validates the timed policy request 400 by verifying that the packet policy identifier 605 identifies a packet policy that exists in the PPR 205 (step 705). If the timed policy request is invalid, an error is returned to the user (step 710). If the timed policy request is valid, the timed policy request is forwarded to the TTA 215 to be scheduled (step 715). The TTA 215 schedules a triggering event for each start time 610 and end time 615 included in the timed policy request 600 (step 720).

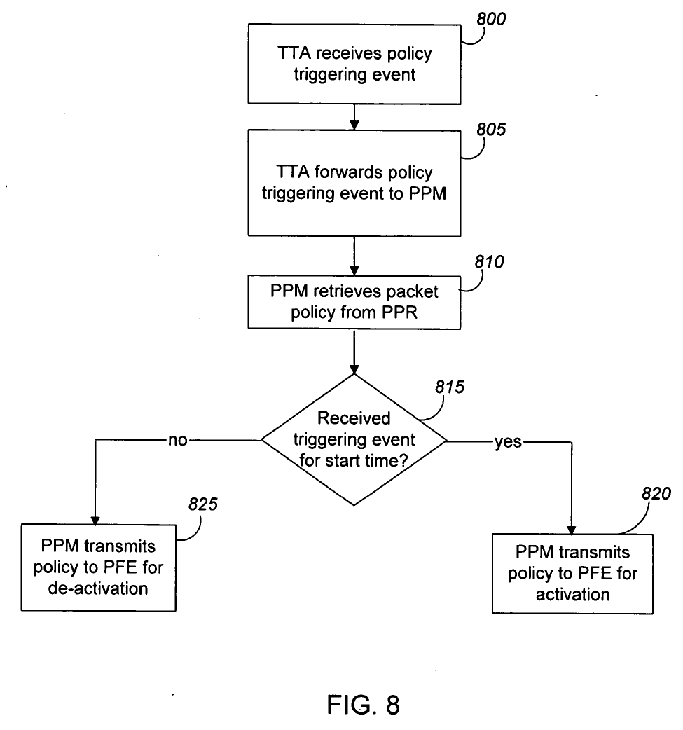

FIG. 8 is a flow diagram illustrating activation of a packet policy scheduled using a timed policy request (400, FIG. 4). Referring to FIG. 2 and FIG. 4, the TTA 215 receives a policy triggering event (step 800), and forwards the policy triggering event to the PPM 210 along with the packet policy identifier 605 associated with the triggering event (step 505). The PPM 210 retrieves the packet policy associated with the triggering event from the PPR 205 using the packet policy identifier 605 (step 810). If the received triggering event is associated with a start time 410 (“yes” branch of decision step 815), the PPM 210 transmits the retrieved policy to the PFE 230 for activation (step 820). If the received triggering event is associated with an end time 615 (“no” branch of decision step 815), the PPM transmits the retrieved packet policy to the PFE 230 for de-activation (step 825).

Techniques for implementing a switch, such as the switch 108, are described in U.S. application Ser. No. 10/445,293, titled “Switch for Local Area Network,” to Sean Hou, William R. Ge, Daniel Yin Yung Ching, Keith M. Andrews, Christopher H. Claudatos, and Magnus B. Hansen, filed on May 22, 2003, which is incorporated by reference herein.

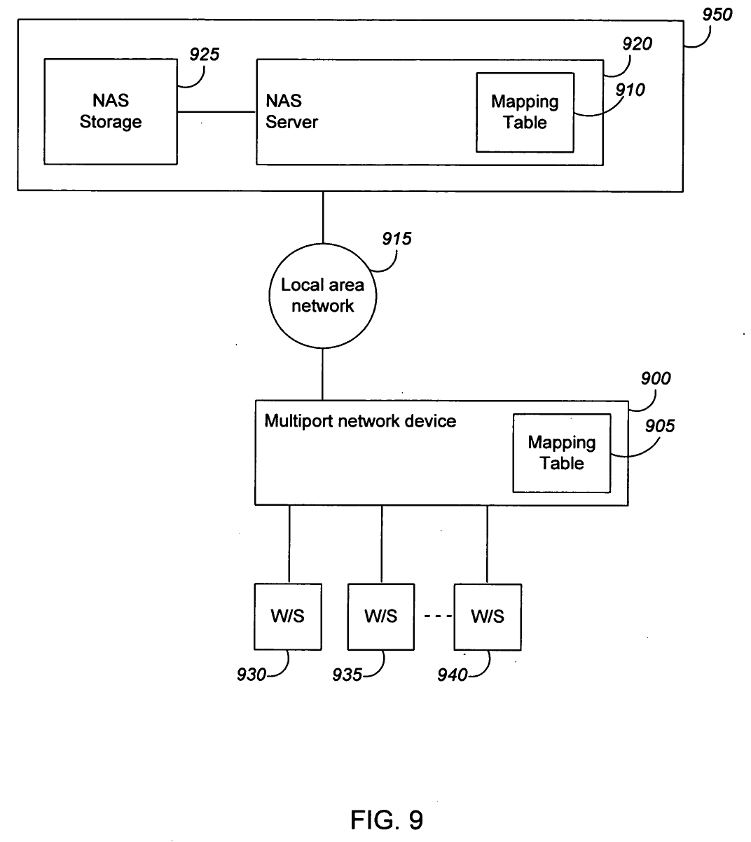

FIG. 9 is a block diagram of one or more user workstations, e.g., workstations 930, 935, and 940 connected to a network-attached storage (NAS) appliance 950 through a local area network 915. The NAS appliance 950 includes a NAS server 920 and a NAS storage unit 925 connected to the NAS server 920. One or more workstations, e.g. workstations 930, 935, and 940 are connected to the NAS server 920 through a multiport network device 900 and the local area network 915. In one implementation, the NAS storage 925 is implemented as a redundant array of independent disks (RAID), and the NAS server 920 is connected to the NAS storage 925 using a Fiber Channel interface. In alternative implementations, the NAS storage 925 is connected to the NAS server 920 using other interfaces, e.g., an iSCSI, InfiniBand, Serial SCSI, Serial Advanced Technology Attachment (SATA), or Gigabit Ethernet. The workstation 930 requests a file from the NAS server 920 and identifies the requested file using an associated file name. The NAS server 920 retrieves the requested file from the NAS storage 925 and transmits the retrieved file to the requesting workstation 930. The NAS server 920 packetizes the retrieved file and transmits the retrieved file to the workstation 930 as one or more data packets. In one implementation, the retrieved file is transmitted as one or more TCP/IP packets. The data packets are received by the multiport network device 900 and routed to the requesting workstation 930 based on a packet header in the data packets. The multiport network device 900 has three or more ports, and is dedicated to communicating data packets between the ports. Each port of the multiport network device 900 can transmit and receive data packets. The multiport network device 900 can be a network switch, multilayer switch 108, or a router. The multiport network device 900 is not a general purpose computing device. The multiport network device 900 processes data packets at wire speed.

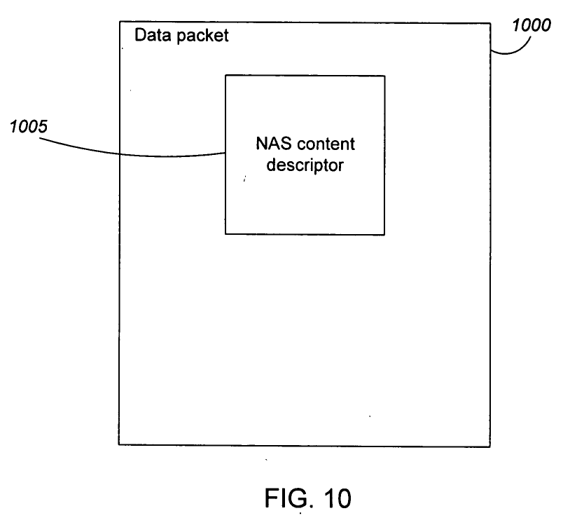

FIG. 10 is a block diagram of the data packet 1000 including a NAS content descriptor 1005. The NAS content descriptor 1005 is inserted by the NAS appliance 950 before transmitting the data packet through the local area network 915. The NAS content descriptor 1005 can be inserted in any unused location in the data packet. The NAS content descriptor 1005 can also be inserted in a reserved or unused portion of the packet header.

The retrieved file transmitted by the NAS server has one or more associated file attributes. The associates file attributes can include one or more of file name, file extension, file size. The associated file attributes can also include data format stored in the file, e.g., text, graphics, audio, video, electronic documents, computer program instructions, and other data or information. The NAS content descriptor 1005 is used to identify the associated file attributes for the data packet. The NAS content descriptor 1005 can also be used to identify data packets that are authorized to use network resources. The multiport network device 900 receiving the data packet uses the NAS content descriptor 1005 to determine the file attributes for the received data packet, and process the data packet based on the NAS content descriptor 1005. Processing the data packet includes selecting one of a plurality of network actions, e.g., the actions listed in Table I. Processing the data packets can include allocating network bandwidth to the received data packet, and monitoring the received data packet as it is routed through the computer network. Processing the data packet can also include blocking data packets from utilizing the computer network, redirecting blocked data packets, logging discarded data packets.

In FIG. 9, the NAS appliance 950 has a mapping table 910, and the multiport network device 900 has a mapping table 905. The mapping table 910 stored at the NAS appliance 950 is a copy of the mapping table 905 stored at the multiport network device 900. The multiport network device 900 determines the NAS content descriptor 1005 inserted by the NAS appliance 950, by copying the mapping table 905 to the mapping table 910. The mapping tables 905 and 910 identify one or more file attributes, and provide the NAS content descriptor 1005 to be inserted for the identified file attributes. In one example, the mapping tables 905 and 910 provide the NAS content descriptor 1005 based on or more of a file name, a file extension, a file size, or a data format of the file being transmitted using the data packet. In one implementation, the mapping table 905 is generated and maintained by a network administrator. The network administrator can periodically update the mapping table 905 to reflect changes in network administration policies. In an alternative implementation, the mapping table 905 stored at the multiport network device 900 is copied to the NAS appliance 950 using a mutually agreed protocol between the multiport network device 900 and the NAS appliance 950.

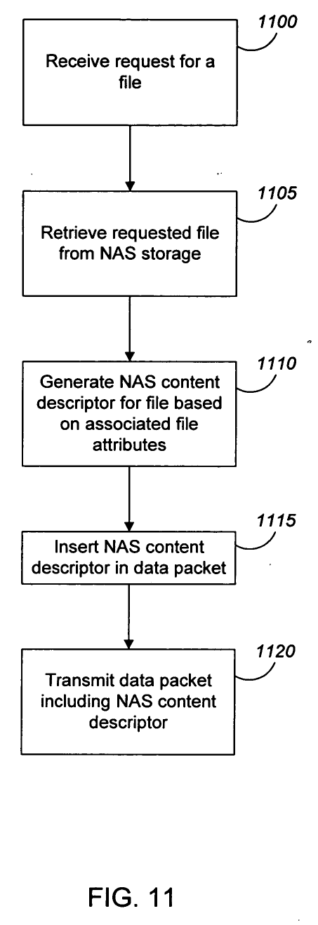

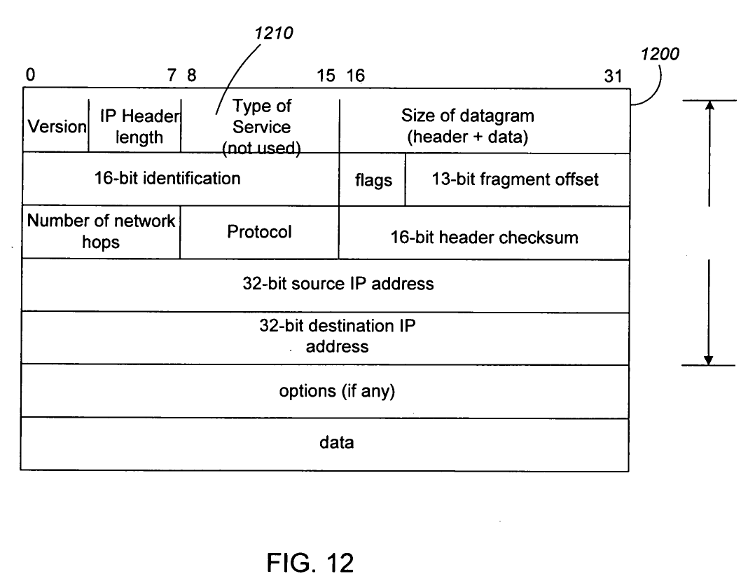

FIG. 11 is a flow diagram illustrating the transmission of data packets containing the NAS content descriptor 1005 by the NAS appliance 950. The NAS appliance 950 receives a request for a file (step 1100), and retrieves the requested file from the NAS storage 925 (step 11105). The NAS server 920 generates a NAS content descriptor 1005 for the retrieved file based on one or more file attributes associated with the retrieved file (step 100). For example, the NAS server 920 can use the file name or the file name extension to retrieve the NAS content descriptor 1005 from the mapping table 910 stored at the NAS server 920. The NAS server 920 inserts the generated NAS content descriptor 1005 in the data packet 1000 (step 1115), and transmits the data packet 1000 including the NAS content descriptor 1005 through the local area network (step 1120). In one implementation, the data packet 1000 includes an IP header 1200 (FIG. 12), and the NAS content descriptor is inserted in unused portions of the IP header 1200. The type of service (ToS) field 1210 (FIG. 12) of the IP header, also referred to as the differentiated services field (DSCP), is typically not used. A part of the ToS field 1210 or the entire ToS field 1210 can be used to insert the NAS content descriptor 1005. In one implementation, six bits of the ToS field are used to insert the NAS content descriptor 1005.

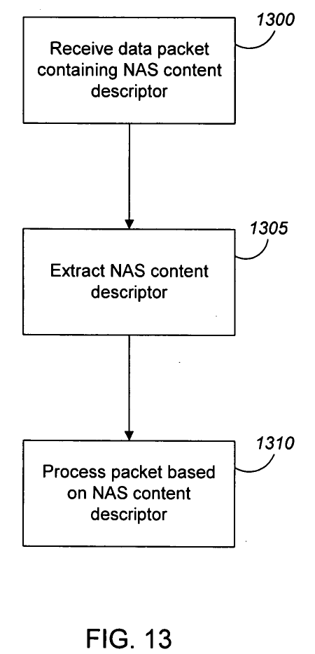

FIG. 13 is a flow diagram illustrating the processing of a data packet 1000 including a NAS content descriptor 1005 by the multiport network device 900. The data packet 1000 including the NAS content descriptor 1005 is received at the multiport network device 900 (step 1300). The multiport network device 900 extracts the NAS content descriptor 1005 from the data packet 1000 (step 1305), and processes the data packet 1000 based on the NAS content descriptor 1005 (step 1310). In one implementation, packet policies can be defined for each NAS content descriptor 1005 specified by the mapping table 905. As described above, the multiport network device 900 can be implemented using a multilayer switch 108 that analyzes the received data packet to determine if there is a matching packet policy and performs actions associated with the matching packet policy. In one implementation, the multiport network device 900 strips the NAS content descriptor 1005 from data packets that are routed to other devices on the computer network.

For example, the systems and techniques described here can be used by the network administrator to limit bandwidth used to access video files stored in the NAS appliance 950 to 64 Kbps. The video files stored on the NAS appliance 950 are marked with a specific file name (or a file name extension) and the network administrator specifies a video content descriptor to be inserted by the NAS appliance 950 for data packets containing video file data. In addition, the network administrator configures the multiport network device 900 to allocate a bandwidth of 64 Kbps to data packets having the specified NAS content descriptor 1005. In an alternative example, the network administrator can allocate unrestricted of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results. Packet analysis and classification may be accomplished utilizing a switch fabric, computer central processing unit (CPU) or a network processing unit (NPU). A switch fabric, providing aggregation over multiple ports can be combined with performing preliminary analysis with a NPU providing deep packet analysis. Additional hardware components can be included in the multiport network device to provide accelerated encryption and decryption of data packets. The multiport network device can include hardware that acts as a PC server, controlling memory allocation, and interface between the multiport network device and stroage media. The multiport network device can also include an appropriate bus interface with a disk array of hard drives or other storage units such that data packets received by the multiport network device can be tagged and stored in the appropriate disk array. The tagged data packets can be retrieved from the disk array and the tag can be stripped from the data packets before routing to other network devices. The tags can be implemented using Extended Markup Language (XML).

1. A computer network comprising:
a network-attached storage appliance generating data packets and transmitting the generated data packets to the computer network, the data packets being generated by packetizing a file, the file having one or more associated file attributes, the network-attached storage appliance inserting a network-attached storage content descriptor in each generated data packet, the content descriptor identifying one or more of the associated file attributes; and
a multiport network device receiving the generated data packets, the multiport network device being configured to process the received data packets according to the content descriptor, the multiport network device processing the received data packets at wire speed.

2. The method of claim 1, wherein the one or more file attributes comprise one or more of file name, file extension, file size, and data format stored in the file.

3. The computer network of claim 1, wherein:
the multiport network device is configured by a user to process the received data packets according to the content descriptor.

4. The computer network of claim 1, wherein:
the multiport network device determines the content descriptor to be inserted by the network-attached storage appliance for the identified content type.

5. The computer network of claim 4, wherein:
a mapping table is stored on the multiport network device, the mapping table identifying one or more file attributes, the mapping table providing the content descriptor to be inserted by the network-attached storage appliance for each of the identified file attributes, the mapping table being transmitted to the network-attached storage appliance, the network-attached storage appliance inserting the content descriptors provided by the mapping table.

6. The computer network of claim 1, wherein processing the data packets at the multiport network device comprises selecting one of a plurality of network actions.

7. The computer network of claim 6, wherein processing the data packets at the multiport network device comprises allocating network bandwidth to the received data packets and monitoring the data packets received at the multiport network device.

8. The computer network of claim 6, wherein:
the multiport network device is configured to process the data packets by blocking data packets from utilizing the computer network, redirecting blocked data packets, and logging blocked data packets.

9. The computer network of claim 6, wherein:
the multiport network device is configured to process the data packets by allocating network bandwidth to the received data packets based on the content type.

10. The computer network of claim 1, wherein:
the associated file attributes for each data packet are determined by the network-attached storage appliance.

11. The computer network of claim 10, wherein:
the generated data packets are generated by packetizing information contained in a file, and the associated file attributes are determined based on a file name identifying the file.

12. The computer network of claim 10, wherein:
the generated data packets are generated by packetizing information contained in a file, and the associated file attributes are determined based on a file name extension of the file.

13. The computer network of claim 1, further comprising:
a workstation connected to the network-attached storage appliance through the multiport network device, the workstation requesting a file from the network-attached storage appliance;
wherein generating the data packets includes generating data packets containing the requested file, and transmitting the generated data packets includes transmitting the generated data packets to the workstation requesting the file.

14. The computer network of claim 1, wherein:
the multiport network device stores one or more user defined packet policies, and is configured to perform an action from a user defined packet policy that matches the content descriptor.

15. The computer network of claim 1, wherein:
the multiport network device is configured to route the received data packet using a layer 2-3 switch.
